(19) United States
(12) Patent Application Publication
(10) Pub. No.: US 2019/0020888 A1
(43) Pub. Date: Jan. 17, 2019

(54) COMPOUND INTRA PREDICTION FOR VIDEO CODING

(71) Applicant: GOOGLE LLC, Mountain View, CA (US)

(72) Inventors: Yuxin Liu, Palo Alto, CA (US); Hui Su, College Park, MD (US)

(21) Appl. No.: 15/646,312

(22) Filed: Jul. 11, 2017

(51) Int. Cl. H04N 19/50; H04N 19/11; H04N 19/105; H04N 19/147; H04N 19/176; H04N 19/593; H04N 21/234

(52) U.S. Cl. CPC H04N 19/50; H04N 19/11; H04N 19/105; H04N 21/234; H04N 19/176; H04N 19/593; H04N 19/147

(57) ABSTRACT

Compound intra prediction is used to encode or decode blocks of video frames. First and second intra-prediction modes are selected based on motion within the video frame. For example, rate-distortion values resulting from predicting the motion can be determined for combinations of intra-prediction modes. The combination including the first and second intra-prediction modes can be selected based on it resulting in the lowest rate-distortion value. A compound prediction block is generated by combining first and second prediction blocks respectively generated using the first and second intra-prediction modes. For example, combining the first and second prediction blocks can include weighting the pixel values of the first and second prediction blocks or using each of those intra-prediction modes with different partitions of the block to be encoded or decoded. That block is then encoded or decoded using the compound prediction block.

### BACKGROUND

Digital video streams may represent video using a sequence of frames or still images. Digital video can be used for various applications including, for example, video conferencing, high definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including encoding or decoding techniques.

### SUMMARY

A method for encoding a current block of a video frame according to an implementation of the disclosure comprises selecting a first intra-prediction mode and a second intra-prediction mode based on motion within the video frame. A compound prediction block is generated by combining a first prediction block generated using the first intra-prediction mode and a second prediction block generated using the second intra-prediction mode. The current block is encoded using the compound prediction block.

A method for decoding an encoded block of an encoded video frame according to an implementation of the disclosure comprises selecting a first intra-prediction mode and a second intra-prediction mode based on motion within the encoded video frame. A compound prediction block is generated by combining a first prediction block generated using the first intra-prediction mode and a second prediction block generated using the second intra-prediction mode. The encoded block is decoded using the compound prediction block.

An apparatus for decoding an encoded block of an encoded video frame according to an implementation of the disclosure comprises a processor configured to execute instructions stored in a non-transitory storage medium. The instructions include instructions to select a first intra-prediction mode and a second intra-prediction mode based on motion within the encoded video frame. A compound prediction block is generated by combining a first prediction block generated using the first intra-prediction mode and a second prediction block generated using the second intra-prediction mode. The encoded block is decoded using the compound prediction block.

These and other aspects of the present disclosure are disclosed in the following detailed description of the embodiments, the appended claims and the accompanying figures.

### BRIEF DESCRIPTION OF THE DRAWINGS

The description herein makes reference to the accompanying drawings described below, wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a typical video stream to be encoded and subsequently decoded.

FIG. 4 is a block diagram of an encoder according to implementations of this disclosure.

FIG. 5 is a block diagram of a decoder according to implementations of this disclosure.

FIG. 6 is a flowchart diagram of an example of a technique for coding a block of a video frame using compound intra prediction.

FIG. 7 is a block diagram of an example of an apparatus for coding a block of a video frame using compound intra prediction.

FIGS. 8A-D are diagrams of examples of blocks divided into partitions for coding using compound intra prediction.

### DETAILED DESCRIPTION

Video compression schemes may include breaking respective images, or frames, into smaller portions, such as blocks, and generating an encoded bitstream using techniques to limit the information included for respective blocks thereof. The encoded bitstream can be decoded to re-create the source images from the limited information. Encoding blocks to or decoding blocks from a bitstream can include predicting the motion within those blocks based on spatial similarities with other blocks in the same frame. Those spatial similarities can be determined using one or more intra-prediction modes. Intra-prediction modes attempt to predict the pixel values of a block using pixels peripheral to the block (e.g., pixels that are in the same frame as the block, but which are outside the block). The result of an intra-prediction mode performed against a block is a prediction block. A prediction residual can be determined based on a difference between the pixel values of the block and the pixel values of the prediction block. The prediction residual can be encoded or decoded, for example, as part of producing an encoded bitstream or output video stream.

There may be multiple intra-prediction modes available for predicting the motion of a block. For example, different intra-prediction modes can be used to perform prediction along different directions with respect to the pixel values of a block to be coded. The intra-prediction modes usable for predicting the motion of the block may be configured to prediction motion in one such direction. However, a block to be coded may be more optimally coded using a combination of intra-prediction modes. For example, motion of the block may be along multiple directions such that the use of a single intra-prediction mode may not effectively predict the motion. This may result in blocking artefacts within an output video stream, such as because the prediction residual encoded using the single intra-prediction mode did not account for motion along other directions.

Implementations of this disclosure include using compound intra prediction to encode or decode blocks of video frames. First and second intra-prediction modes are selected based on motion within the video frame. For example, rate-distortion values resulting from predicting the motion can be determined for combinations of intra-prediction modes. The combination including the first and second intra-prediction modes can be selected based on it resulting in the lowest rate-distortion value. A compound prediction block is generated by combining first and second prediction blocks respectively generated using the first and second intra-prediction modes. For example, combining the first and second prediction blocks can include weighting the pixel values of the first and second prediction blocks or using each of those intra-prediction modes with different partitions of the block to be encoded or decoded. That block is then encoded or decoded using the compound prediction block.

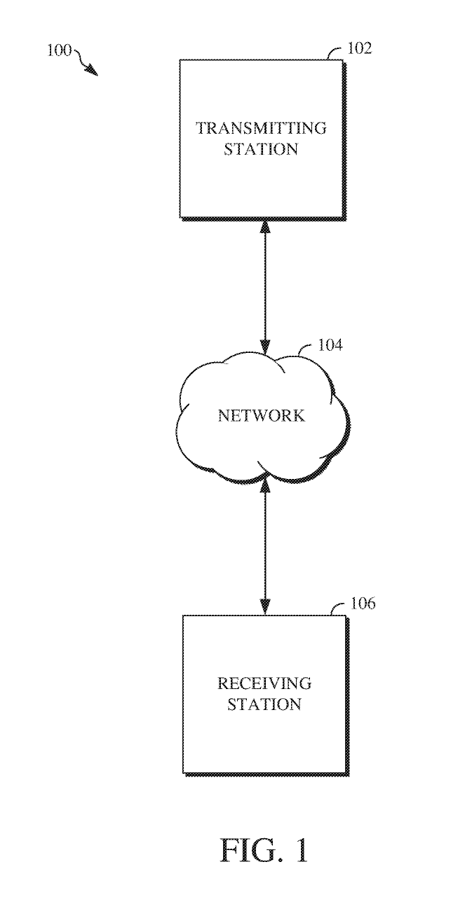

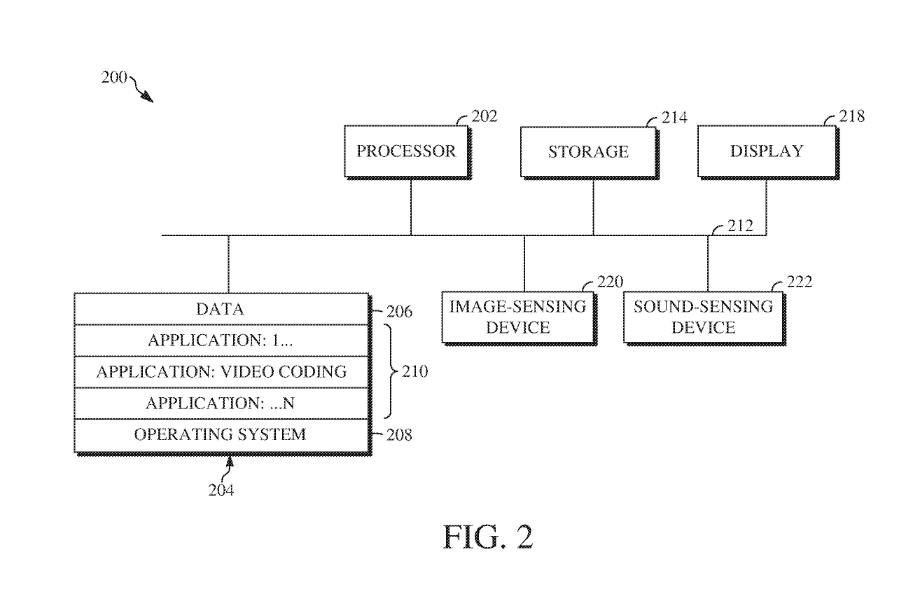

Further details of techniques for video coding using compound intra-prediction are described herein with initial reference to a system in which they can be implemented. FIG. 1 is a schematic of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used (e.g., a Hypertext Transfer Protocol-based (HTTP-based) video streaming protocol).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include a video coding application that performs the techniques described herein. The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

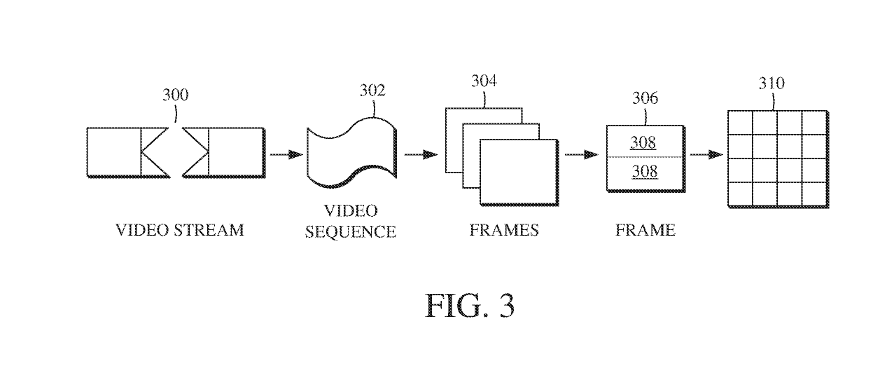

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

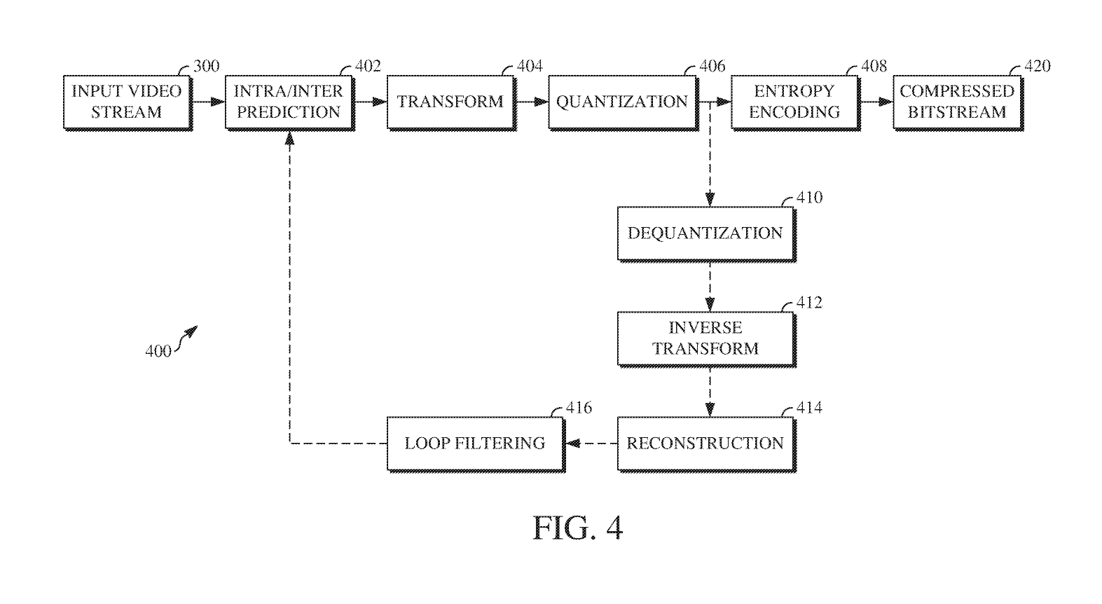

FIG. 4 is a block diagram of an encoder 400 according to implementations of this disclosure. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

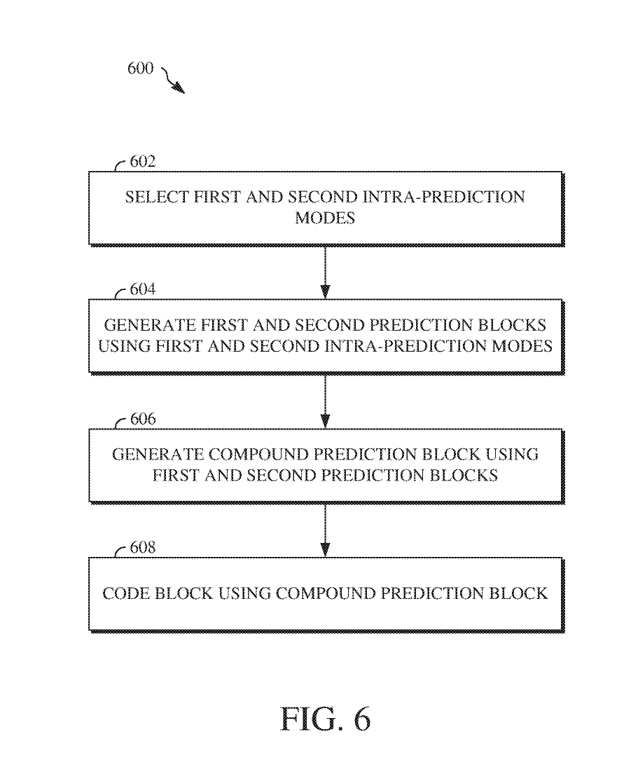

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. For example, the intra/inter prediction stage 402 can include using compound intra prediction to encode a block of a video frame. Implementations for encoding blocks of video frames using compound intra prediction are described below with respect to FIGS. 6-8D. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process (described below), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

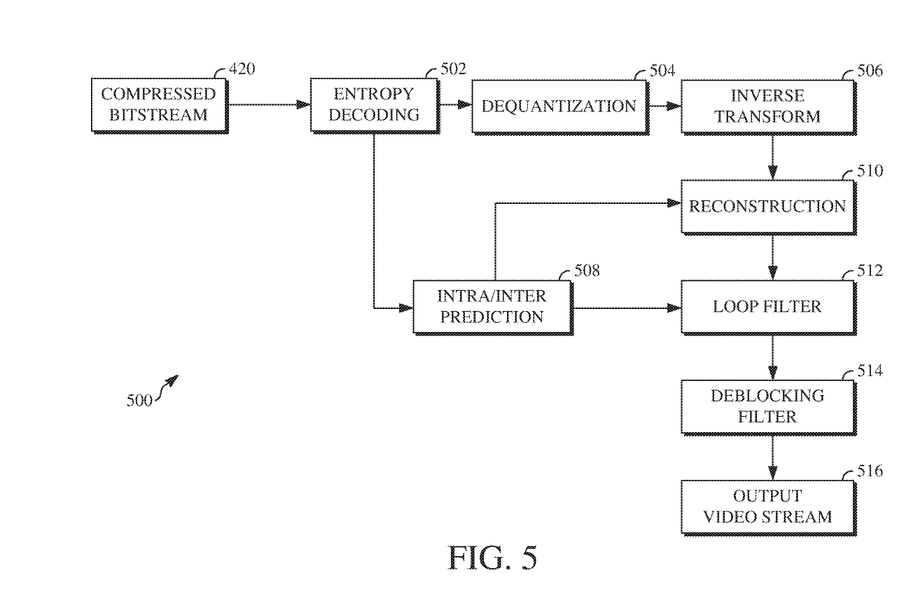

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. For example, the intra/inter prediction stage 508 can include using compound intra prediction to decode an encoded block of an encoded video frame. Implementations for decoding encoded blocks of encoded video frames using compound intra prediction are described below with respect to FIGS. 6-8D.

At the reconstruction stage 510, the prediction block can be added to the derivative residual to create a reconstructed block. The loop filtering stage 512 can be applied to the reconstructed block to reduce blocking artifacts. Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. In some implementations, the decoder 500 can produce the output video stream 516 without the deblocking filtering stage 514.

Referring next to FIG. 6, a technique for using compound intra prediction is described. FIG. 6 is a flowchart diagram of a technique 600 for coding a block of a video frame using compound intra prediction. The technique 600 can be implemented, for example, as a software program that may be executed by computing devices such as the transmitting station 102 or the receiving station 106. For example, the software program can include machine-readable instructions that may be stored in a memory such as the memory 204 or the secondary storage 214, and that, when executed by a processor, such as the processor 202, may cause the computing device to perform the technique 600. The technique 600 can be implemented using specialized hardware or firmware. As explained above, some computing devices may have multiple memories or processors, and the operations described in the technique 600 can be distributed using multiple processors, memories, or both.

The technique 600 may be performed by an encoder, for example, the encoder 400 shown in FIG. 4, or by a decoder, for example, the decoder 500 shown in FIG. 5. As such, references within the below descriptions of the technique 600 may include discussion of encoding a current block or decoding an encoded block. All or a portion of the technique 600 may be used to encode a current block or decode an encoded block. Therefore, references to “encoding the current block,” or the like within the discussion of the technique 600 may also be wholly or partially relevant for the decoding process. Similarly, references to “decoding the encoded block,” or the like within the discussion of the technique 600 may also be wholly or partially relevant for the encoding process.

At 602, two or more intra-prediction modes to use for coding a block of a video frame are selected based on motion within the video frame. For example, a first intra-prediction mode and a second intra-prediction mode may be selected. The intra-prediction modes that may be selected may be stored in a database, table, or other data store accessible by a hardware or software component performing the selecting. For example, a table may include records associated with the selectable intra-prediction modes. The different intra-prediction modes may be configured for prediction motion in different directions. Selecting the first and second intra-prediction modes may, for example, include reading or otherwise using information stored in records pertaining to those first and second intra-prediction modes.

The intra-prediction modes to use for coding the block may be selected based on a rate-distortion analysis performed with respect to combinations of the selectable intra-prediction modes. For example, the selecting may include determining rate-distortion values resulting from predicting the motion within the video frame including the block to be coded using different combinations of the intra-prediction modes. A rate-distortion value refers to a ratio that balances an amount of distortion (e.g., a loss in video quality) with rate (e.g., a number of bits) for coding a block or other video component. Determining a rate-distortion value for a combination of intra-prediction modes can include predicting motion of the block to be coded using that combination. The combination of intra-prediction modes resulting in a lowest one of the rate-distortion values can be determined such that the intra-prediction modes of that combination are selected.

For example, a combination including a first intra-prediction mode and a second intra-prediction mode may be selected by determining that such combination results in the lowest rate-distortion value determined based on the rate-distortion analysis. Rate-distortion values can be determined for every possible combination of the intra-prediction modes. Alternatively, a specified number of combinations may be identified such that the number of rate-distortion values determined is limited. The specified number of combinations may be configurable, such as by a user of an encoder or decoder. Alternatively, the specified number of combinations may be non-configurable, such as where it is set by default.

At 604, prediction blocks are generated using the selected intra-prediction modes. Generating a prediction block using a selected intra-prediction mode can include predicting motion of the block to be coded based on characteristics of the selected intra-prediction mode (e.g., use of neighbor motion information, direction, or the like). For example, when first and second intra-prediction modes are selected, a first prediction block can be generated using the first intra-prediction mode and a second prediction block can be generated using the second intra-prediction mode.

At 606, a compound prediction block is generated. The compound prediction block is generated by combining the prediction blocks generated using the selected intra-prediction modes. For example, where first and second intra-prediction blocks are generated, generating the compound prediction block can include combining the first and second intra-prediction blocks. The prediction blocks generated using the selected intra-prediction modes can be combined using one or more techniques. For example, the prediction blocks can be combined based on weights associated with the intra-prediction modes. In another example, the prediction blocks can be combined based on partitions of the block to be coded. Other examples for combining the prediction blocks may also be possible.

Combining the prediction blocks based on weights associated with the intra-prediction modes used to generate those prediction blocks includes determining weighted pixel values based on those weights. For example, where first and second prediction blocks are to be combined, the combining can include determining first weighted pixel values by applying a first weight to pixel values of the prediction block generated using the first intra-prediction mode and determining second weighted pixel values by applying a second weight to pixel values of the prediction block generated using the second intra-prediction mode. The first weighted pixel values and the second weighted pixel values are then averaged to generate the compound prediction block.

The weights associated with the intra-prediction modes can be specified, such as within a default configuration of an encoder or decoder used to code the block. Alternatively, the weights associated with the intra-prediction modes may be determined, for example, by a user of the encoder or decoder, according to probabilities indicating the use of those intra-prediction modes, based on the use of those intra-prediction modes to code neighbor blocks, or the like, or a combination thereof.

Combining the prediction blocks based on partitions of the block to be coded includes dividing the block to be coded into multiple partitions. Partitioning definitions indicating how to divide the block to be coded (e.g., the number, shapes, or sizes of partitions resulting therefrom) may be specified, such as within a configuration of an encoder or decoder used to code that block. Alternatively, information indicating how to divide that block into partitions may be indicated, for example, by a user of the encoder or decoder, based on partitions resulting from divisions of neighbor blocks, or the like. Portions of the prediction blocks corresponding to those partitions are then combined to generate the compound prediction block. For example, where first and second prediction blocks are to be combined, the combining can include dividing the block to be coded into a first partition and a second partition and combining a portion of the first prediction block corresponding to the first partition with a portion of the second prediction block corresponding to the second partition.

At 608, the block of the video frame is coded using the compound prediction block. During an encoding process (e.g., performed using an encoder, such as the encoder 400 shown in FIG. 4), coding the block using the compound prediction block can include encoding a current block using the compound prediction block, such as by encoding a prediction residual resulting from using the compound prediction block to a compressed bitstream. During a decoding process (e.g., performed using an decoder, such as the decoder 500 shown in FIG. 5), coding the block using the compound prediction block can include decoding an encoded block using the compound prediction block, such as by decoding a prediction residual resulting from using the compound prediction block to an output video stream.

For simplicity of explanation, the technique 600 is depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

In some implementations, more than two intra-prediction modes may be used to generate the compound prediction block. For example, weighted pixels determined based on multiple weights for multiple prediction blocks can be averaged to combine those multiple prediction blocks. In another example, the current block may be partitioned into multiple partitions where the motion in respective partitions is predicted using corresponding portions of different intra-prediction blocks.

In some implementations, an encoder and a decoder may perform the technique 600 in different ways. For example, during a decoding process, selecting the intra-prediction modes to use to decode an encoded block can include decoding one or more syntax elements from an encoded bitstream. The one or more syntax elements can indicate the particular intra-prediction modes used for encoding the encoded block. For example, the one or more syntax elements may include bits encoded to a frame header of the encoded bitstream. The bits may refer to identifiers of the intra-prediction modes used to encode the encoded block. For example, those identifiers may be included in a table, database, or other data store that includes records associated with the intra-prediction modes that may be selected for encoding or decoding blocks.

In another example, during a decoding process, the compound prediction block can be generated using information encoded within the encoded bitstream including the encoded block to decode. For example, during a corresponding encoding process, an encoder can encode one or more syntax elements (e.g., to a header of the video frame including the block being encoded) indicating the weights associated with the intra-prediction modes used, the partitions by which the block is divided, or the like. This information can be received from the encoded bitstream and used to generate the compound prediction block.

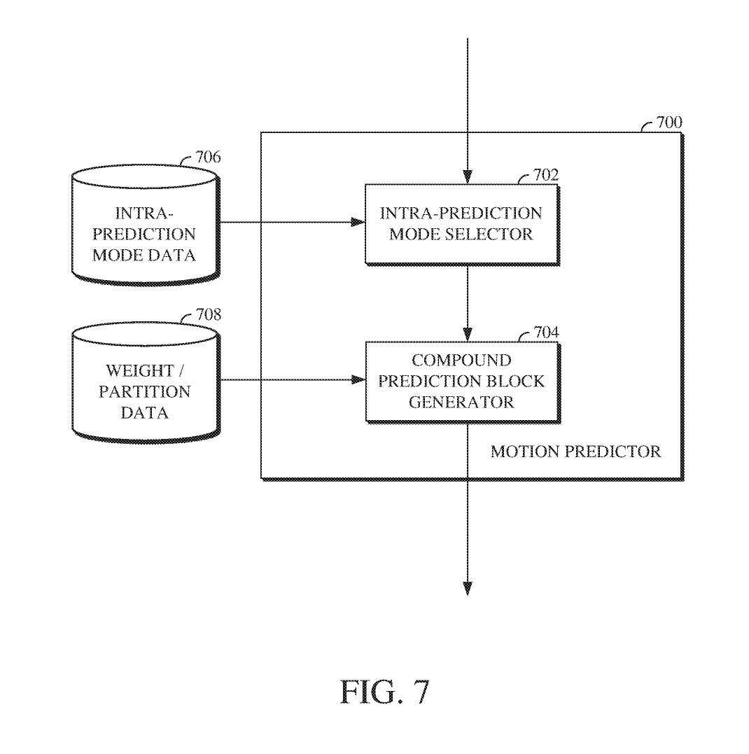

FIG. 7 is a block diagram of an example of an apparatus for coding a block of a video frame using compound intra prediction. The apparatus may, for example, be one of the transmitting station 102 or the receiving station 106 shown in FIG. 1. The apparatus includes a motion predictor 700. The motion predictor 700 is software including functionality for predicting the motion for a block of a video frame to be coded, such as by performing all or a portion of the technique 600 shown in FIG. 6. For example, the motion predictor 700 may include instructions or code for implementing the intra/inter prediction stage 402 shown in FIG. 4 or the intra/inter prediction stage 508 shown in FIG. 5. In another example, the motion predictor 700 may include instructions or code for implementing all or a portion of the reconstruction path shown in FIG. 4 (e.g., by the dotted connection lines therein).

The motion predictor 700 includes an intra-prediction mode selector 702 and a compound prediction block generator 704. The intra-prediction mode selector 702 is software including functionality for selecting two or more intra-prediction modes based on motion within a video frame including a block to be coded. The compound prediction block generator 704 is software including functionality for generating a compound prediction block by combining prediction blocks generated using the two or more intra-prediction modes selected using the intra-prediction mode selector 702. The intra-prediction mode selector 702 and the compound prediction block generator 704 may include portions of the instructions or code comprising the motion predictor 700.

The intra-prediction mode selector 702 selects the two or more intra-prediction modes using intra-prediction mode data 706. The intra-prediction mode data 706 can be stored in a database, table, or other data store including data used to identify intra-prediction modes available for predicting motion within the video frame including the block to be coded. The intra-prediction mode data 706 can, for example, include a table storing identifiers or other information for the intra-prediction modes usable by an encoder or decoder to respectively encode or decode the block. For example, the information stored in the table may include information indicating a particular technique, direction, or other characteristic, or combination thereof for predicting motion within the video frame. The different intra-prediction modes may be configured for prediction motion in different directions.

The intra-prediction mode selector 702 determines rate-distortion values resulting from predicting the motion within the video frame using combinations of the intra-prediction modes referenced by the intra-prediction mode data 706. That is, the intra-prediction mode selector 702 may select different combinations of the intra-prediction modes and perform a rate-distortion analysis to determine the combination resulting in the lowest rate-distortion value. A combination of the intra-prediction modes selected from the intra-prediction mode data 706 may include two or more of the intra-prediction modes referenced by the intra-prediction mode data 706. The intra-prediction mode selector 702 can determine a rate-distortion value for every possible combination of the intra-prediction modes. Alternatively, the intra-prediction mode selector 702 can determine rate-distortion values for a specified number of the possible combinations, which specified number may or may not be configurable.

Information indicating the intra-prediction modes that, when combined, result in the lowest rate-distortion value is passed along to the compound prediction block generator 704. The compound prediction block generator 704 generates a compound prediction block used for coding the block of the video frame by combining prediction blocks generated using ones of the intra-prediction modes selected using the intra-prediction mode selector 702. For example, where the intra-prediction mode selector 702 selects a first intra-prediction mode and a second intra-prediction mode (e.g., based on a combination of those first and second intra-prediction modes resulting in a lowest rate-distortion value), the compound prediction block generator 704 combines a first intra-prediction block generated using the first intra-prediction mode and a second intra-prediction block generated using the second intra-prediction mode to generate the compound prediction block.

Generating a prediction block using a selected intra-prediction mode can include using motion data associated with neighbor blocks of the block to be coded to predict the motion within that block to be coded. For example, previously-coded left and above neighbor blocks of the block to be coded can be used to derive the data usable for predicting the motion within the block to be coded. The prediction blocks associated with the selected intra-prediction modes can be generated by the compound prediction block generator 704. Alternatively, the prediction blocks associated with the selected intra-prediction modes can be generated by the intra-prediction mode selector 702. As yet another alternative, the prediction blocks associated with the selected intra-prediction modes can be generated by other software of or associated with the motion predictor 700.

The compound prediction block generator 704 uses weight/partition data 708 to generate the compound prediction block. The weight/partition data 708 can be stored in a database, table, or other data store including data used to identify weights associated with intra-prediction modes and/or techniques for partitioning the block to be coded based on intra-prediction modes, such as the intra-prediction modes associated with the intra-prediction mode data 706. For example, the weight/partition data 708 can include a first table storing weight data, which indicates the weights that have been associated with ones of the intra-prediction modes associated with the intra-prediction mode data 706. In another example, the weight/partition data 708 can include a second table storing partition data, which indicates how to partition a block to be coded using combinations of those intra-prediction modes.

The prediction blocks generated using the selected intra-prediction modes may be combined based on the weight data or the partition data. Combining the prediction blocks based on the weight data of the weight/partition data 708 can include determining weighted pixel values for each of those prediction blocks by applying respective weights indicated by the weight data to pixel values of those prediction blocks. For example, where first and second prediction blocks are generated (e.g., respectively based on first and second intra-prediction modes selected using the intra-prediction mode selector 702), combining the prediction blocks based on the weight data can include averaging first weighted pixel values determined for the first prediction block and second weighted pixel values determined for the second prediction block.

Combining the prediction blocks based on the partition data of the weight/partition data 708 can include dividing the block to be coded into multiple partitions and using corresponding partitions of the prediction blocks to form the compound prediction block. For example, where first and second prediction blocks are generated (e.g., respectively based on first and second intra-prediction modes selected using the intra-prediction mode selector 702), combining the prediction blocks based on the partition data can include dividing the block to be coded into a first partition and a second partition. A portion of the first prediction block corresponding to the first partition is combined with a portion of the second prediction block corresponding to the second partition to generate the compound prediction block.

Implementations of the apparatus shown in FIG. 7 may include additional, less, or different functionality than shown. In some implementations, the intra-prediction mode selector can select the intra-prediction modes to be passed along to the compound prediction block generator 704 based on data encoded within an encoded bitstream. For example, during a decoding process, an encoded bitstream is received, such as from an encoder, a server relaying the bitstream, or the like. The encoded bitstream may, for example, be the compressed bitstream 420 shown in FIG. 4. An encoded video frame of the encoded bitstream includes the encoded block to be decoded.

The encoded bitstream may also include one or more syntax elements indicating the intra-prediction modes used for encoding the encoded block. For example, those one or more syntax elements may be encoded to the encoded bitstream during an encoding process resulting in the encoded bitstream. The one or more syntax elements may, for example, include one or more bits used to identify the intra-prediction modes used to encode the encoded block. For example, the one or more bits can be included in a query of the intra-prediction mode data 706. The query can return the intra-prediction modes associated with those one or more bits, for example, where the identifiers of those intra-prediction modes are referenced using those one or more bits.

In some implementations, the data used by the motion predictor 700 may be stored in more or fewer databases, tables, or other data stores than as described above. For example, the intra-prediction mode data 706 and the weight/partition data 708 may be stored in the same database, table, set of tables, or other data store. In another example, separate databases, tables, or other data stores may be used to store different subsets of the weight/partition data 708. For example, a first database, table, set of tables, or other data store may be used to store the weight data of the weight/partition data 708 and a different database, table, set of tables, or other data store may be used to store the partition data of the weight/partition data 708.

In some implementations, the apparatus described with respect to FIG. 7 may be one component of a system for coding blocks of video frames using compound intra prediction. A system for coding blocks of video frames using compound intra prediction may include one or more computing devices, such as the computing device 200 shown in FIG. 2. For example, one computing device may be a transmitting station, such as the transmitting station 102 shown in FIG. 1. Another computing device may be a receiving station, such as the receiving station 106 shown in FIG. 1. Another computing device may be a computing device for communicating data between the transmitting station and the receiving station, such as a server device associated with a network, such as the network 104 shown in FIG. 1.

In another example, one or more computing devices can be used to encode the blocks using compound intra prediction and one or more other computing devices can be used to decode those encoded blocks. For example, each of the transmitting station and the receiving station may use another computing device as part of a process for encoding blocks using compound intra prediction, such as a device on which one or both of the intra-prediction mode data 806 or the weight/partition data 808 is stored. The transmitting station and the receiving station may use the same or a different computing device for the respective encoding or decoding operations.

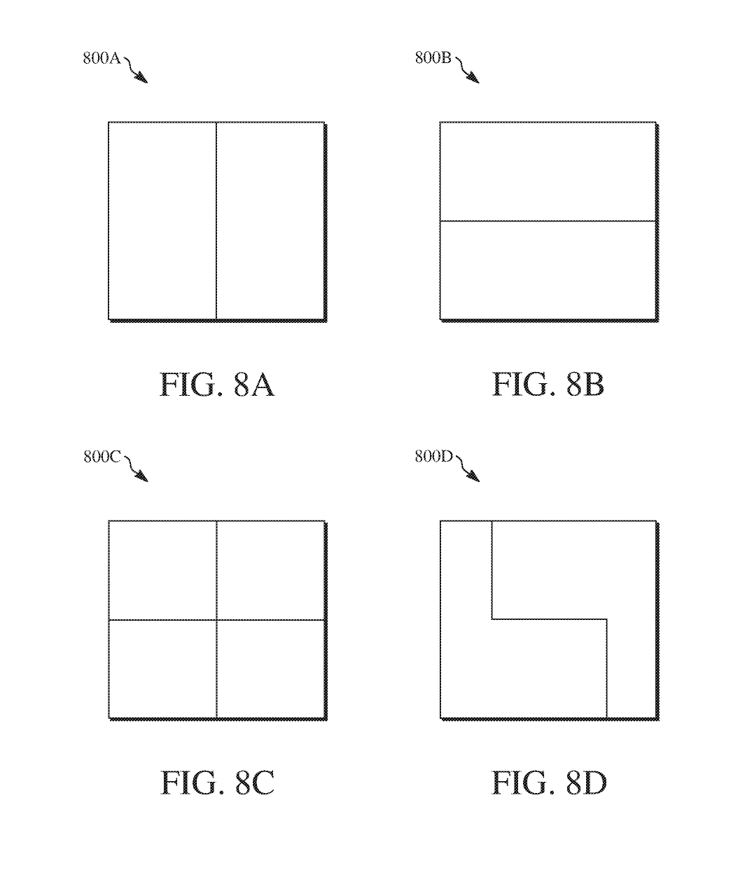

FIGS. 8A-D are diagrams of examples of blocks 800A, 800B, 800C, 800D divided into partitions for coding using compound intra prediction. The blocks 800A, 800B, 800C, 800D may show different partitions for the same block to be encoded or decoded. Alternatively, the blocks 800A, 800B, 800C, 800D may show partitions of different blocks to be encoded or decoded. In FIG. 8A, the block 800A is shown with a vertical partition dividing the block 800A into a left partition and a right partition. For example, a first intra-prediction mode can be used to predict the motion in the left partition and a second intra-prediction mode can be used to predict the motion in the right partition. In FIG. 8B, the block 800B is shown with a horizontal partition dividing the block 800B into an upper partition and a lower partition. For example, a first intra-prediction mode can be used to predict the motion in the upper partition and a second intra-prediction mode can be used to predict the motion in the lower partition.

However, there may be more than one partition used to divide a block to be coded, such as where more than two intra-prediction modes are selected for the coding. In FIG. 8C, the block 800C is shown with horizontal and vertical partitions dividing the block 800C into four quadrants. The use of the two partitions may result from four intra-prediction modes being selected for coding the block 800C. For example, a first intra-prediction mode can be used to predict the motion in the upper-left partition, a second intra-prediction mode can be used to predict the motion in the upper-right partition, a third intra-prediction mode can be used to predict the motion in the lower-left partition, and a fourth intra-prediction mode can be used to predict the motion in the lower-right partition.

Further, the partitions resulting from dividing a block to be coded may not be rectangular. In FIG. 8D, the block 800D is shown with two L-shaped non-rectangular partitions resulting from a combined vertical/horizontal division. For example, a first intra-prediction mode can be used to predict the motion in the leftmost non-rectangular partition and a second intra-prediction mode can be used to predict the motion in the rightmost non-rectangular partition. Other implementations of partitions resulting from dividing a block to be coded are possible. In some implementations, there may be more than two non-rectangular partitions. In some implementations, the partitions may not include to equal numbers of coefficients of the block. In some implementations, one or more partitions of the block may be defined in whole or in part by oblique or curved borders.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described embodiments, implementations, and aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method for encoding a current block of a video frame, the method comprising:
selecting a first intra-prediction mode and a second intra-prediction mode based on motion within the video frame;
generating a compound prediction block by combining a first prediction block generated using the first intra-prediction mode and a second prediction block generated using the second intra-prediction mode; and
encoding the current block using the compound prediction block.

2. The method of claim 1, wherein selecting the first intra-prediction mode and the second intra-prediction mode based on motion within the video frame comprises:
determining rate-distortion values resulting from predicting the motion within the video frame using combinations of intra-prediction modes; and
determining that a combination including the first intra-prediction mode and the second intra-prediction mode results in a lowest one of the rate-distortion values.

3. The method of claim 1, wherein generating the compound prediction block by combining the first prediction block and the second prediction block comprises:
determining first weighted pixel values by applying a first weight to pixel values of the first prediction block;
determining second weighted pixel values by applying a second weight to pixel values of the second prediction block; and
averaging the first weighted pixel values and the second weighted pixel values.

4. The method of claim 3, further comprising:
associating the first intra-prediction mode with the first weight and the second intra-prediction mode with the second weight.

5. The method of claim 1, wherein generating the compound prediction block by combining the first prediction block and the second prediction block comprises:
dividing the current block into a first partition and a second partition; and
combining a portion of the first prediction block corresponding to the first partition and a portion of the second prediction block corresponding to the second partition.

6. The method of claim 5, wherein the current block is divided into the first partition and the second partition according to partitioning definitions of an encoder used to encode the current block.

7. A method for decoding an encoded block of an encoded video frame, the method comprising:
selecting a first intra-prediction mode and a second intra-prediction mode based on motion within the encoded video frame;
generating a compound prediction block by combining a first prediction block generated using the first intra-prediction mode and a second prediction block generated using the second intra-prediction mode; and
decoding the encoded block using the compound prediction block.

8. The method of claim 7, wherein selecting the first intra-prediction mode and the second intra-prediction mode based on motion within the encoded video frame comprises:
decoding, from an encoded bitstream including the encoded video frame, one or more syntax elements indicating that the first intra-prediction mode and the second intra-prediction mode were used for encoding the encoded block.

9. The method of claim 7, wherein selecting the first intra-prediction mode and the second intra-prediction mode based on motion within the encoded video frame comprises:
determining rate-distortion values resulting from predicting the motion within the encoded video frame using combinations of intra-prediction modes; and
determining that a combination including the first intra-prediction mode and the second intra-prediction mode results in a lowest one of the rate-distortion values.

10. The method of claim 7, wherein generating the compound prediction block by combining the first prediction block and the second prediction block comprises:
determining first weighted pixel values by applying a first weight to pixel values of the first prediction block;
determining second weighted pixel values by applying a second weight to pixel values of the second prediction block; and
averaging the first weighted pixel values and the second weighted pixel values.

11. The method of claim 10, further comprising:
associating the first intra-prediction mode with the first weight and the second intra-prediction mode with the second weight.

12. The method of claim 7, wherein generating the compound prediction block by combining the first prediction block and the second prediction block comprises:
dividing the encoded block into a first partition and a second partition; and
combining a portion of the first prediction block corresponding to the first partition and a portion of the second prediction block corresponding to the second partition.

13. The method of claim 12, wherein the encoded block is divided into the first partition and the second partition according to partitioning definitions of a decoder used to decode the encoded block.

14. An apparatus for decoding an encoded block of an encoded video frame, the apparatus comprising:
a processor configured to execute instructions stored in a non-transitory storage medium to:
select a first intra-prediction mode and a second intra-prediction mode based on motion within the encoded video frame;
generate a compound prediction block by combining a first prediction block generated using the first intra-prediction mode and a second prediction block generated using the second intra-prediction mode; and
decode the encoded block using the compound prediction block.

15. The apparatus of claim 14, wherein the instructions to select the first intra-prediction mode and the second intra-prediction mode based on motion within the encoded video frame include instructions to:
decode, from an encoded bitstream including the encoded video frame, one or more syntax elements indicating that the first intra-prediction mode and the second intra-prediction mode were used for encoding the encoded block.

16. The apparatus of claim 14, wherein the instructions to select the first intra-prediction mode and the second intra-prediction mode based on motion within the encoded video frame include instructions to:
determine rate-distortion values resulting from predicting the motion within the encoded video frame using combinations of intra-prediction modes; and
determine that a combination including the first intra-prediction mode and the second intra-prediction mode results in a lowest one of the rate-distortion values.

17. The apparatus of claim 14, wherein the instructions to generate the compound prediction block by combining the first prediction block and the second prediction block include instructions to:
determine first weighted pixel values by applying a first weight to pixel values of the first prediction block;
determine second weighted pixel values by applying a second weight to pixel values of the second prediction block; and
average the first weighted pixel values and the second weighted pixel values.

18. The apparatus of claim 17, wherein the instructions include instructions to:
associate the first intra-prediction mode with the first weight and the second intra-prediction mode with the second weight.

19. The apparatus of claim 14, wherein the instructions to generate the compound prediction block by combining the first prediction block and the second prediction block include instructions to:
divide the encoded block into a first partition and a second partition; and
combine a portion of the first prediction block corresponding to the first partition and a portion of the second prediction block corresponding to the second partition.

20. The apparatus of claim 19, wherein the encoded block is divided into the first partition and the second partition according to partitioning definitions of a decoder used to decode the encoded block.
